(19) United States
(12) Patent Application Publication
(10) Pub. No.: US 2025/0182771 A1
(43) Pub. Date: Jun. 5, 2025

(54) Speech Enhancement

(71) Applicant: Nokia Technologies Oy, Espoo (FI)

(72) Inventors: Juha Tapio Vilkamo, Helsinki (FI); Jussi Kalevi Virolainen, Espoo (FI)

(21) Appl. No.: 18/958,012

(22) Filed: Nov. 25, 2024

(30) Foreign Application Priority Data
Dec. 5, 2023 (GB) 2318554.9

(51) Int. Cl. G10L 21/02

(52) U.S. Cl. CPC G10L 21/02

(57) ABSTRACT

Examples of the disclosure relate to enabling adjustment of speech enhancement processing. In examples of the disclosure one or more audio signals are obtained during audio communication. At least one quality value for at least one of the obtained one or more audio signals is determined. Adjustment of speech enhancement processing used for at least one of the one or more obtained audio signals is enabled wherein the adjustment is based, at least in part, on the quality value.

### TECHNOLOGICAL FIELD

Examples of the disclosure relate to speech enhancement. Some relate to enabling adjustment of speech enhancement processing.

### BACKGROUND

Speech enhancement processing can be used to improve audio quality in teleconferencing systems and other types of systems. Speech enhancement processing can increase latency which can be problematic. For instance, this can cause participants in a teleconferencing system to talk over each other which can be frustrating.

### BRIEF SUMMARY

According to various, but not necessarily all, examples of the disclosure there is provided an apparatus for speech enhancement processing comprising means for:
obtaining one or more audio signals during audio communication;
determining at least one quality value for at least one of the obtained one or more audio signals; and
enabling adjustment of speech enhancement processing used for at least one of the one or more obtained audio signals wherein the adjustment is based, at least in part, on the quality value.

The determined quality value may be based on at least one of:
latency associated with the obtained one or more audio signals;
noise levels in the obtained one or more audio signals;
coding/decoding bit rates associated with the obtained one or more audio signals.

The determined quality value may be determined using a machine learning model.

The speech enhancement processing may be adjusted to operate with smaller latency if the determined quality value indicates at least one of:
that the latency associated with the obtained one or more audio signals is higher,
that the noise levels in the obtained one or more audio signals is lower.

The speech enhancement processing may be adjusted to operate with larger latency if the determined quality value indicates at least one of:
that the latency associated with the obtained one or more audio signals is lower,
that the noise levels associated with the obtained one or more audio signals is higher.

Adjusting speech enhancement processing may comprise selecting at least one of a plurality of available modes for use in speech enhancement processing.

The means may be for selecting a window function for performing one or more transforms of the one or more audio signals, wherein the window function is selected based, at least in part, on the selected mode.

Two or more audio signals may be obtained.

A first quality value may be determined for a first obtained audio signal and a second, different quality value may be determined for a second obtained audio signal; and
a first speech enhancement processing is applied to the first obtained audio signal based, at least in part, on the first quality value and a second speech enhancement processing is applied to the second obtained audio signal based, at least in part, on the second quality value, wherein the first speech enhancement processing and the second speech enhancement processing have different latencies.

The obtained one or more audio signals may comprise at least one of;
one or more mono audio signals,
one or more stereo audio signals;
one or more multichannel audio signals;
one or more spatial audio signals.

The speech enhancement processing may comprise at least one of:
speech denoising;
automatic gain control;
bandwidth extension.

According to various, but necessarily all examples of the disclosure there may be provided a teleconferencing system comprising an apparatus as described herein.

According to various, but necessarily all examples of the disclosure there may be provided a method comprising:
obtaining one or more audio signals during audio communication;
determining at least one quality value for at least one of the obtained one or more audio signals; and
enabling adjustment of speech enhancement processing used for at least one of the one or more obtained audio signals wherein the adjustment is based, at least in part, on the quality value.

According to various, but necessarily all examples of the disclosure there may be provided a computer program comprising instructions which, when executed by an apparatus, cause the apparatus to perform at least:
obtaining one or more audio signals during audio communication;
determining at least one quality value for at least one of the obtained one or more audio signals; and
enabling adjustment of speech enhancement processing used for at least one of the one or more obtained audio signals wherein the adjustment is based, at least in part, on the quality value.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

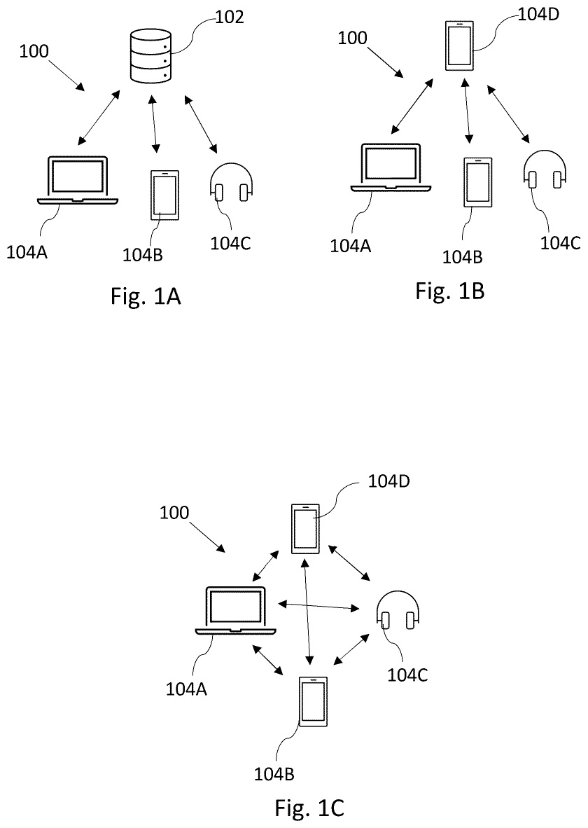

FIGS. 1A to 1C show example systems;

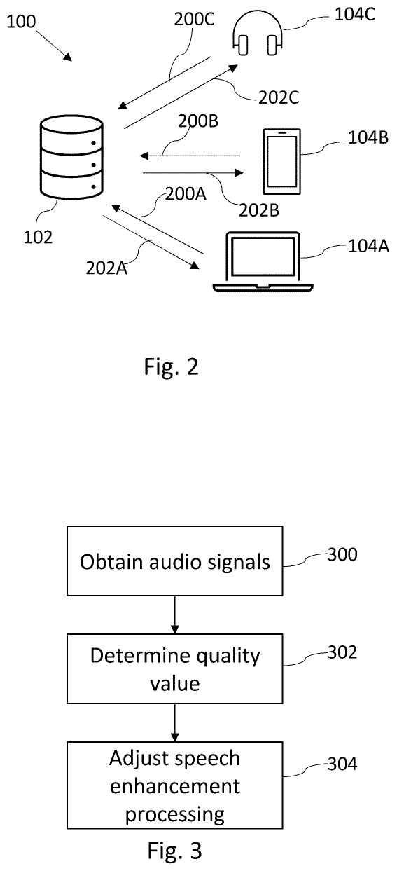

FIG. 2 shows an example system;

FIG. 3 shows an example method;

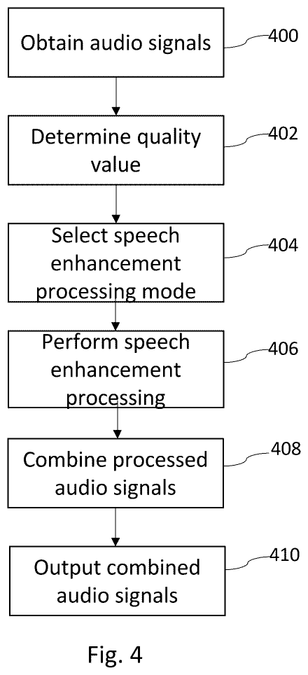

FIG. 4 shows another example method;

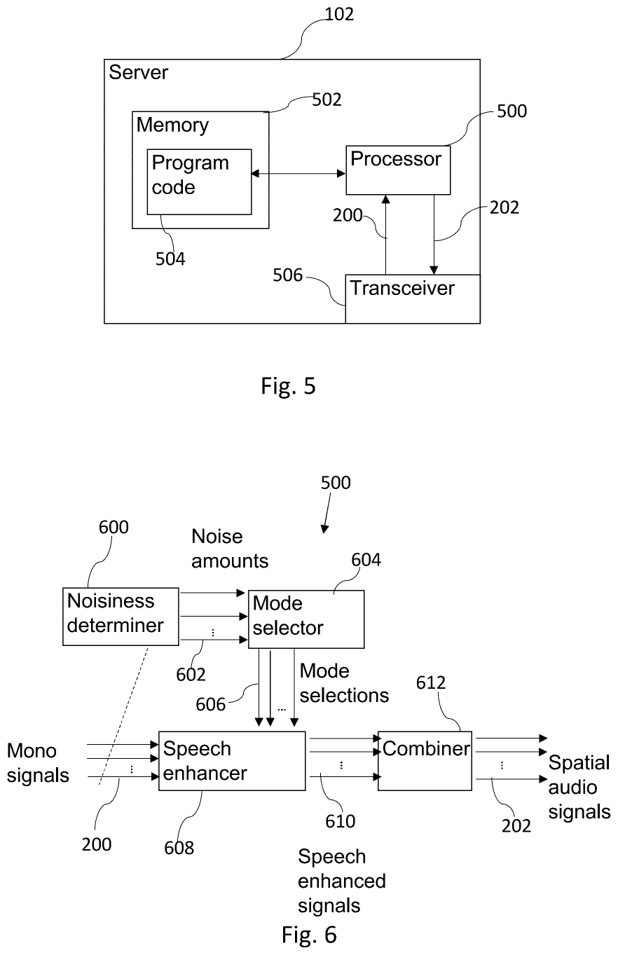

FIG. 5 shows an example server;

FIG. 6 shows an example processor;

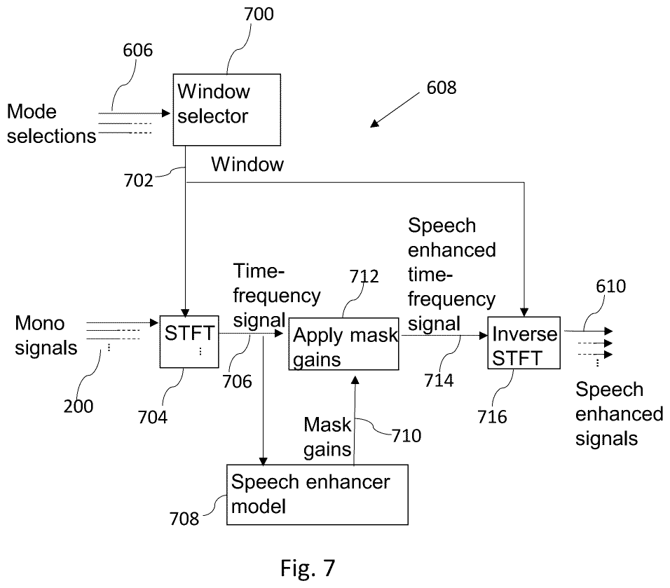

FIG. 7 shows an example speech enhancer;

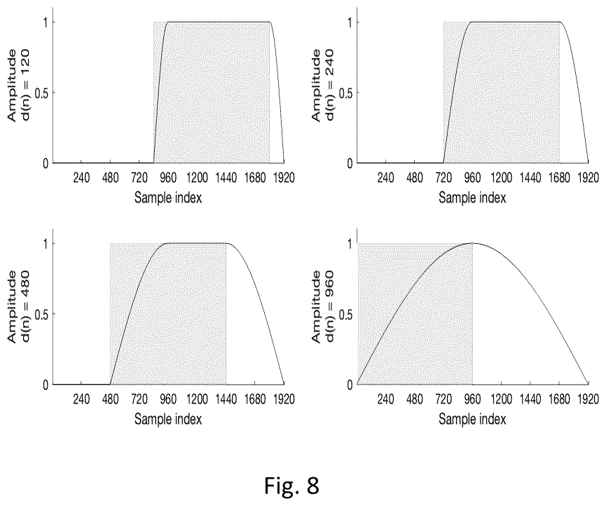

FIG. 8 shows example window functions;

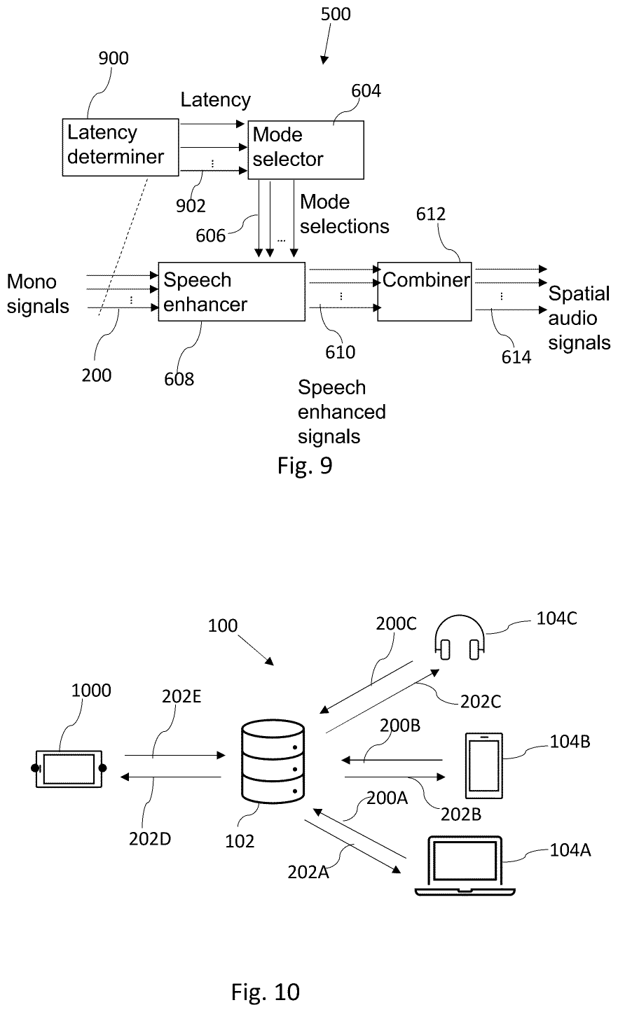

FIG. 9 shows an example processor;

FIG. 10 shows an example system;

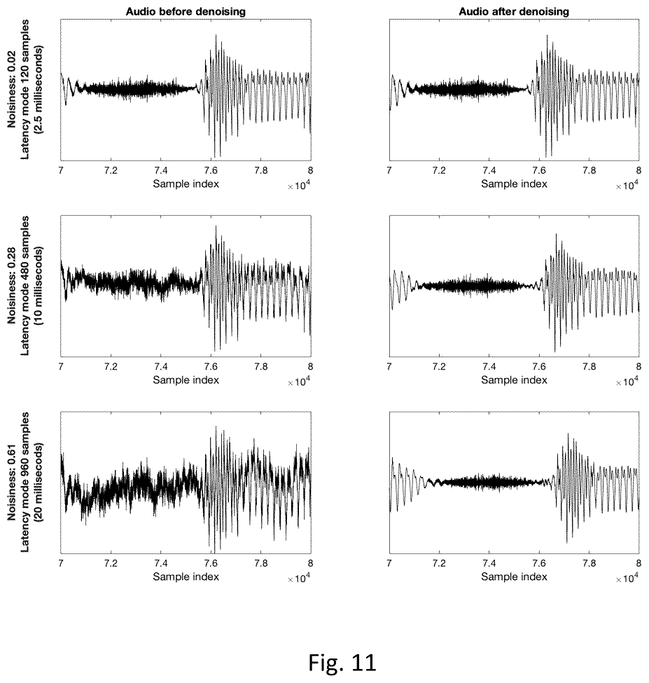

FIG. 11 shows example results; and

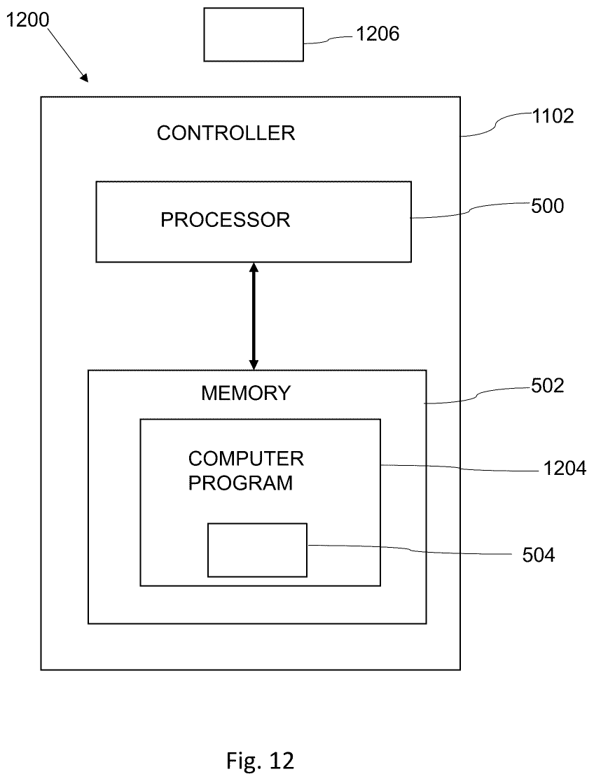

FIG. 12 show an example apparatus.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Corresponding reference numerals are used in the figures to designate corresponding features. For clarity, all reference numerals are not necessarily displayed in all figures.

### DETAILED DESCRIPTION

FIGS. 1A to 1C show systems 100 that can be used to implement examples of the disclosure. In these examples the systems 100 are teleconferencing systems. The teleconferencing systems can enable speech, or other similar audio content, to be exchanged between different client devices 104 within the system 100. Other types of audio content can be shared between the respective devices in other examples.

In the example of FIG. 1A the system 100 comprises a server 102 and multiple client devices 104. The server 102 can be a centralized server that provides communication between the respective client devices 104.

In the example of FIG. 1A three client devices 104 are shown. The system 100 could comprise any number of client devices 104 in implementations of the disclosure. The client devices 104 can be used by participants in a teleconference, or other communication session, to listen to audio. The audio can comprise speech or any other suitable type of audio content or combinations of types of audio.

The client devices 104 comprise means for capturing audio. The means for capturing audio can comprise one or more microphones. The user devices 104 also comprise means for playing back audio to a participant. The means for playing back audio to a participant can comprise one or more loudspeakers. In FIG. 1A a first client device 104A is a laptop computer, a second client device 104B is a smart phone and a third client device 104C is a headset. Other types, or combinations of types, of client devices 104 could be used in other examples.

During a teleconference, the respective client devices 104 send data to the central server 102. This data can comprise audio captured by the one or more microphones of the client devices 104. The server 102 then combines and processes the received data and sends appropriate data to each of the client devices 104. The data sent to the client devices 104 can be played back to the participants.

FIG. 1B shows a different system 100. In this system 100 a client device 104D acts as a server and provides the communication between the other client devices 104A-C. In this example the system 100 does not comprise a server 102 because the client device 104D performs the function of the server 102.

In this example the client device 104D that performs the function of the server 102 is a smart phone. Other types of client device 104 could be used to perform the functions of the server 102 in other examples.

FIG. 1C shows another different system 100 in which the respective client devices 104 communicate directly with each other in a peer-to-peer network. In this example, the system 100 does not comprise a server 102 because the respective client devices 104 communicate directly with each other.

Other arrangements for the system 100 could be used in other examples.

FIG. 2 shows the example system 100 of FIG. 1A in more detail. In this example the server 102 is connected to multiple client devices 104 so as to enable a communications session such as a teleconference between the respective client devices 104.

The server 102 can be a spatial teleconference server. The spatial teleconference server 102 is configured to receive mono audio signals 200 from the respective client devices 104. The server 102 processes the received mono audio signals 200 to generate spatial audio signals 202. The spatial audio signals 202 can then be transmitted to the respective client devices 104.

The spatial audio signals 202 can be any audio signals that are not mono audio signals 200. The spatial audio signals 202 can enable a participant to perceive spatial properties of the audio content. The spatial properties could comprise a direction for one or more sound sources. In some examples the spatial audio signals 202 can comprise stereo signals, binaural signals, multi-channel signals, ambisonics signals, metadata-assisted spatial audio (MASA) signals or any other suitable type of signal. MASA signals can comprise one or more transport audio signals and associated spatial metadata. The metadata can be used by the client device 104 to render a spatial audio output of any suitable kind based on the transport audio signals. For example, the client device 104 can use the metadata to process the transport audio signals to generate a binaural or surround signal.

The communications paths for the audio signals 200, 202 can comprise multiple processing blocks. The communication paths may comprise encoding, decoding, multiplexing, demultiplexing and/or any other suitable processes. For example, the audio signals and/or associated data can be encoded so as to optimize, or substantially optimize, the bit rate. The encoding could be AAC (Advanced Audio Coding), EVS (Enhanced Voice Services) or any other type of encoding. In some examples different encoded signals can be multiplexed into one or more combined bit streams. In some examples the different signals can be encoded in a joint fashion so that the features of one signal type affects the encoding of another. An example of this would be that the activity of an audio signal would affect the bit allocation for any corresponding spatial metadata encoder. When encoding and/or multiplexing has taken place at a device sending data, the corresponding receiving device will apply the corresponding decoding and/or demultiplexing.

In the example of FIG. 2 the respective client devices 104 send mono audio signals 200 to the server 102. The server 102 receives multiple mono audio signals 200. The server 102 uses the received multiple mono audio signals 200 to generate spatial audio signals 202 for the respective client devices 104. The spatial audio signals 202 are typically unique to the client devices 104 so that different client devices 104 receive different spatial audio signals 202.

The communication path may also comprise speech denoising. The speech denoising can comprise any processing that removes or reduces noise from audio signals comprising speech and/or improves the intelligibility of the speech in the audio signals.

In some examples the server 102 can perform the speech denoising. In some examples the speech denoising can be performed by the respective client devices 104. If the speech denoising is performed by the client devices 104 then the server 102 can control the client devices to perform the speech denoising. In the following examples it is assumed that the server 102 is performing the denoising.

Speech denoising results in a compromise between latency and obtained quality. For example, lookahead can be useful in detecting is an onset is speech of a different type of sound.

Higher latency can provide an improved speech denoising performance. For example, a more effective speech denoising performance can be provided if the speech denoiser can process the audio in finer frequency resolution such that it can pass through speech harmonics while significantly suppressing noise between the harmonics. However, in digital signal processing the higher frequency selectivity results in higher latency. For example, a filter bank with a higher frequency resolution (number of frequency bins and/or higher stop-band attenuation) is obtained with a cost of higher latency.

However, latency is adverse for teleconferencing. With increased latency, participants are more likely to talk over each other. This can be frustrating for the participants in the teleconference.

The latency can be configured to a lower setting to prevent the issues with the participants in the teleconference talking over each other. However, this would reduce the performance of the speech denoiser and reduce the quality of the audio in the teleconference. Examples of the disclosure provide speech enhancement processes that can address these issues.

FIG. 3 shows an example method that can be used in examples of the disclosure. The method could be implemented using teleconferencing systems such as the systems 100 shown in FIGS. 1A to 1C and FIG. 2. The method can be implemented using apparatus for speech enhancement processing. The apparatus could be in a server 102 or a client device 104 or any other suitable electronic device.

At block 300 the method comprises obtaining one or more audio signals. The one or more audio signals can be obtained during audio communication. The obtaining of the audio signals is ongoing. Some audio signals will have been obtained, processed and played back to a user to provide audio communication. The obtaining of the audio signals can occur simultaneously with the processing and play back of earlier audio signals.

Any multiple number of audio signals can be obtained at block 300. In some examples two or more audio signals can be obtained.

The obtained one or more audio signals can comprise at least one of, one or more mono audio signals, one or more stereo audio signals; one or more multichannel audio signals; one or more spatial audio signals; or any other suitable type of signals.

At block 302 the method comprises determining at least one quality value for at least one of the obtained one or more audio signals. The quality value can be a numerical parameter. The quality value can provide an indication of noise levels in the audio signals, latency associated with the audio signals, intelligibility of speech in the audio signals, and/or any other suitable factor.

The quality value can be based on one or more factors. In some examples the factor can comprise latency associated with the obtained one or more audio signals. The latency can be the network latency and/or the audio algorithm processing latency (for other reasons than speech enhancement). The network latency describes a one-way delay time to transport data from a sender to a receiver. This could describe for example, client to server latency. The audio algorithm processing latency describes how much an audio signal is delayed when it propagates through signal processing algorithms

In some examples the factors that the quality value can be based on can comprise noise levels in the obtained one or more audio signals.

In some examples the factors that the quality value can be based on can comprise coding/decoding bit rates associated with the obtained one or more audio signals.

The quality value can be determined using any suitable means. In some examples the quality value can be determine using a machine learning model.

At block 304 the method comprises enabling adjustment of speech enhancement processing used for at least one of the one or more obtained audio signals. The adjustment is based, at least in part, on the quality value. For example, the quality value can be used to determine whether the speech enhancement processing should adjusted to operate with smaller latency or with a larger latency.

The speech enhancement processing can comprise any processing that reduces or removes noise in speech audio signals and/or improves the intelligibility of the speech. In some examples the speech enhancement processing comprises at least one of: speech denoising; automatic gain control; bandwidth extension, and/or any other type of processing.

The adjustment of the speech enhancement can be performed by the apparatus or can be controlled by the apparatus and performed by a different device. For example, a server 102 can enable adjustment of speech enhancement processing at one or more client device 104.

The speech enhancement processing can be adjusted to operate with different latencies to change the overall latency associated with the one or more audio signals.

The speech enhancement processing can be adjusted to operate with smaller latency if the determined quality value indicates that the latency associated with the obtained one or more audio signals is higher, or that the noise levels in the obtained one or more audio signals is lower. The latency and/or the noise levels can be determined to be higher or lower compared to static threshold. In some examples the latency and/or the noise levels can be determined to be higher or lower compared to dynamic values, for example, the latency and/or the noise levels in audio signals obtained at different times could be compared.

The speech enhancement processing can be adjusted to operate with larger latency if the determined quality value indicates that the latency associated with the obtained one or more audio signals is lower, or that the noise levels associated with the obtained one or more audio signals is higher. The latency and/or the noise levels can be determined to be lower or higher compared to static threshold. In some examples the latency and/or the noise levels can be determined to be lower or higher compared to dynamic values, for example the latency and/or the noise levels in audio signals obtained at different times could be compared.

Adjusting a speech enhancement processing can comprise making any suitable changes to a speech enhancement processing that is used for the obtained audio signals. In some examples adjusting speech enhancement processing can comprise selecting at least one of a plurality of available modes for use in speech enhancement processing. In some examples multiple modes can be used for speech enhancement at the same time. For instance, a first mode could be used for received signal A and a second mode could be used for received signal B. Adjusting the speech enhancement processing could comprise changing one or more of the multiple modes that are used.

In some examples the adjusting of the speech enhancement processing can comprise selecting a window function for performing one or more transforms of the one or more audio signals. The window function can be selected based, at least in part, on the selected mode.

In some examples multiple quality values can be determined. The different quality values can be determined for different obtained audio signals. For example, a first quality value can be determined for a first obtained audio signal and a second, different quality value can be determined for a second obtained audio signal.

The different quality values can be used to enable different adjustments to be made to different speech enhancement processing. For instance, a first speech enhancement processing can be applied to the first obtained audio signal based, at least in part, on the first quality value and a second speech enhancement processing can be applied to the second obtained audio signal based, at least in part, on the second quality value. The first speech enhancement processing and the second speech enhancement processing can have different latencies.

FIG. 4 shows another example method that can be used in examples of the disclosure. The method could be implemented using teleconferencing systems such as the systems 100 shown in FIGS. 1A to 1C and FIG. 2. The method can be implemented using apparatus for speech enhancement processing. The apparatus could be in a server 102 or any other suitable electronic device.

At block 400 the method comprises obtaining one or more audio signals. The one or more audio signals can be obtained during audio communication. The obtained one or more audio signals can comprise at least one of, one or more mono audio signals, one or more stereo audio signals; one or more multichannel audio signals; one or more spatial audio signals; or any other suitable type of signals.

The obtained audio signals can be received from one or more client devices 104 and/or obtained in any other manner.

At block 402 the method comprises determining at least one quality value for at least one of the obtained one or more audio signals. The quality value can provide an indication of noise levels in the audio signals, latency associated with the audio signals, intelligibility of speech in the audio signals, and/or any other suitable factor. The quality values can be as described in any of the examples and can be obtained using any of the methods described herein.

At block 404 a speech enhancement processing mode is selected for the obtained one or more audio signals. The speech enhancement processing mode can be selected based, at least in part, on the determined quality value. The speech enhancement processing can be a denoiser processing, or any other suitable type of processing.

For instance, if the quality value indicates that the obtained audio signal has a lower noise then the speech enhancement processing mode can be selected to operate with a lower latency. This is because even if the lower latency operation generally entails for example a higher amount of processing artefacts at speech enhancement, when the noise levels are low then these artefacts may be small or negligible. Similarly, if the quality value indicates that the obtained audio signal has a higher latency then the speech enhancement processing mode can be selected to operate with a lower latency. This lower latency operation may entail higher amount of processing artefacts, but in some situations the compromise is preferred to enable the lower latency. If the quality value indicates that the obtained audio signal has a higher noise then the speech enhancement processing mode can be selected to operate with a higher latency. Similarly, if the quality value indicates that the obtained audio signal has a lower latency then the speech enhancement processing mode can be selected to operate the enhancement process with a higher latency.

The respective levels of noise, latency and any other characteristics can be compared to those of audio signals obtained at different times. For example, audio signals obtained at an earlier time can be used.

At block 406 the speech enhancement is performed. The speech enhancement can be performed by the server 102. In some examples the server 102 can control other devices to perform the speech enhancement. The speech enhancement can be performed using the speech enhancement processing mode that was selected at block 404.

At block 408 the processed audio signals are combined. Combining the processed audio signals can comprise generating a parametric spatial audio signal based on the processed audio signals, or any other suitable combining.

At block 410 the combined audio signals are output. The server 102 can output the combined audio signals to the client devices 104. The output signals can be transmitted to the client devices 104. The respective client devices 104 can receive an individual combined audio signal comprising the audio signals from all the other participants.

In the example of FIG. 4 it is assumed that the method is implemented by a server 102. A shown in FIGS. 1B and 1C, in some examples a client device 104 can perform the function of the server 102. In such cases at least one of the audio signals would be “obtained” from the client device 104 itself and a combined audio signal would be “output” to itself.

In some examples the combining of the processed audio signals can comprise creating a spatial audio signal for reproduction with the same device that is acting as the server 102. For instance, the combining could comprise generating a binaural audio signal that can be reproduced to participant over headphones. In such cases the outputting would comprise the reproducing of the audio over the headphones.

In the example of FIG. 4 a server device 102 determines the quality value and selects a speech enhancement processing mode. In other examples one or more other devices, such as a client device 104, could perform at least some of these functions.

FIG. 5 shows an example server 102 that could be used to implement examples of the disclosure. The server 102 could be part of a system as shown in FIG. 1A or 2.

In the example of FIG. 5 the server 102 comprises a processor 500, a memory 502 and a transceiver 506. The memory 502 can comprise program code 504 that provides the instructions that can be used to implement the examples described herein.

The transceiver 506 can be used to receive one or more mono audio signals 200. The mono audio signals 200 can be received from one or more client devices 104. Other types of audio signals, such as spatial audio signals, can be received in other examples. The transceiver 506 can also be configured to output one or more combined audio signals. The combined audio signals can be transmitted to one or more client devices 104. The combined audio signals can be transmitted to the client device 104 from which the mono audio signals were received. The combined audio signals can be spatial audio signals 202. The spatial audio signals 202, or other types of combined audio signals, can be generated using methods described herein.

The processor 500 is configured to access the program code 504 in the memory 502. The processor can execute the instructions of the program code 504 to process the obtained audio signals. The processor 500 can apply any suitable decoding, demultiplexing, multiplexing and encoding to the signals when receiving or sending them.

The program code 504 that is stored in the memory 502 can comprise one or more trained machine-learning network. The trained machine learning network, can comprise multiple defined processing steps, and can be similar to the processing instructions related to conventional program code. The difference between conventional program code and the trained machine-learning network is that the instructions of the conventional program code are defined more explicitly at the programming time. The instructions of the trained machine-learning network are defined by combining a set of predefined processing blocks (such as convolutions, data normalizations, other operators), where the weights of the network are unknown at the network definition time. The weights of the machine learning network are optimized by providing the network with a large amount of input and reference data, and the network weights then converge so that the network learns to solve a given task. In examples of the disclosure, when the trained machine-learning network would be used, the trained machine-learning network would be fixed and would correspond to a set of processing instructions.

Only components that are referred to in the above description are shown in FIG. 5. The server 102 could comprise other components that are not shown in FIG. 5. The other components could depend on the use case of the server 102. For instance, the server 102 could be configured to receive, process and send other data such as video data. In some examples one or more of the client devices 104 could perform the functions of the server 102. Such client devices 104 could comprise microphones and headphones or loudspeakers coupled with a wired or wireless connection, and/or any other suitable components in addition to those shown in FIG. 5.

FIG. 6 shows an example operation of the processor 500 for some examples of the disclosure. In a practical implementation, some of the blocks or operators can be merged or split into different subroutines, or can be performed in different order than described.

The processor receives mono audio signals 200 as an input. Any number of mono audio signals 200 can be received. The mono audio signals 200 can be received from one or more client devices 104. In other examples other types of audio signals, such as spatial audio signals, can be received.

The mono audio signals 200 can be received in any suitable format. In some examples the mono audio signals 200 can be received in a time domain format. The time domain format could be Pulse Code Modulation (PCM) or any other suitable format.

The processor 500 is configured to monitor the mono audio signals 200 with a noisiness determiner 600. The noisiness determiner 600 determines the amount of noise in the mono audio signals 200. Any suitable process can be used to determine the amount of noise in the mono audio signals 200. In some examples the noisiness determiner 600 can be configured to apply a voice activity detector (VAD) to determine the temporal intervals for which speech is occurring within the respective mono audio signals 200. The amount of noise can then be determined by comparing the measured average sound energy in the temporal intervals when speech is active to the average sound energy in the temporal intervals when speech is not active.

In some examples the noisiness determiner 600 can use a machine learning model. The machine learning model can predict spectral mask gains to suppress noise from speech, and then monitor the amount these gains would suppress signal energy. The more the machine learning model suppresses sound energy, the more noise the corresponding signal is expected to have.

In some examples a machine learning model used by the noisiness determiner 600 can use a time-frequency representation of the mono audio signals 200. In the following notation one of the mono audio signals 200 is processed, and same processing can be repeated to all of them. The time-frequency representation of one of the mono audio signals 200 can be denoted S(b, n) where b is the frequency bin index and n is a time index. The machine learning model can determine a set of real-valued gains g(b, n) between 0 and 1 based on the time-frequency representation of the audio signals S(b, n). These gain values, if applied to the mono audio signal provide the estimated speech portion of the signal

$${S}_{speech} = g ( b , n ) S ( b , n )$$

Similarly, an estimated remainder portion could be

$${S}_{remainder} = ( 1 - g ( b , n ) ) S ( b , n ) .$$

Even if the machine learning model predicts the gains based on time-frequency representation of the mono audio signal, the machine learning model can also comprise various pre- or post-processing steps. These steps can be a part of the machine learning model itself or can be performed separately before and/or after performing an inference stage processing with the machine learning model.

Examples of pre-processing steps could comprise data normalization to a specific standard deviation and any mapping of the audio spectral representation to a logarithmic frequency resolution. Examples of post-processing steps could be any re-mapping of the data from logarithmic resolution to linear, and any limiters, such as limiting the mask gains between 0 and 1.

In some examples the machine learning model can receive other input information in addition to the mono audio signals 202. In some examples there is a shared machine learning model enhancing the speech in the mono audio inputs at the same time, as opposed to having a separate instance for each of them.

The inference with a machine learning model can be performed by having pre-trained model weights and the definition of the model operations stored in a TensorFlow Lite format or any other suitable format. The processor 500 that is performing the inference can use an inference library that can be initialized based on the stored model. There can be other means to perform inference with a machine learning model. The trained machine learning model can be in any suitable format such as plain program code because the inference is fundamentally a set of conventional signal processing operations.

The noisiness determiner 600 can be configured to apply a short-time Fourier transform (STFT) operation to the mono audio signals 200. The STFT operation can be one with a cosine window, 960 sample hop size and 1920-point Fast Fourier Transform (FFT) size, to obtain S(b, n) based on the mono audio signals 200. This operation can be performed independently for the mono audio signals 200 from the respective client devices 104. The notation S(b, n) refers to each of them independently.

The noisiness determiner 600 can then predict the gains g(b,n). Any suitable procedure can be used to predict the gains. In some examples the procedure can comprise converting the audio data into a specific logarithmic frequency resolution before the inference stage processing, and then mapping the gains back to the linear frequency resolution.

Temporally smoothed noise and overall energies can be determined for example by;

$${E}_{n} ( n ) = {E}_{n} ( n - 1 ) * α + ( 1 - α ) {\sum }_{b = 1}^{B} ( 1 - g ( b , n ) ) {\vert S ( b , n ) \vert}^{2}$$

$${E}_{o} ( n ) = {E}_{o} ( n - 1 ) * α + ( 1 - α ) {\sum }_{b = 1}^{B} {\vert S ( b , n ) \vert}^{2}$$

where B is the number of bins (961 in this example), α is a temporal smoothing constant, for example, 0.999 and Eₙ(0)=Eₒ(0)=0. In some examples the value a starts from a small value and then reaches the target value, for example, 0.999, to ensure fast initial convergence.

The noisiness determiner 600 provides noise amounts 602 as an output. The noise amounts 602 can be determined independently for the respective input mono audio signals 200. The noise amounts 602 that are output can be formulated by;

$$N ( n ) = \frac{{E}_{n} ( n )}{{E}_{o} ( n )}$$

The values of the noise amounts 602 vary between 0 and 1 where 0 indicates no noise and 1 indicates only noise and the values in between 0 and 1 indicate differing amounts of noise. The values of the noise amounts 602 can indicate general noisiness of the received mono audio signals 200, in a slowly changing temporal fashion. Note that the noise amounts 602 can be defined separately for each of the received mono audio signals 200.

The noise amounts 602 can be an example of a quality value and can be used to control an adjustment to speech enhancement processing. In some examples other parameters could be used as the quality value. Other parameters could be an algorithmic delay or latency related to other processing than the speech enhancement processing.

The noise amounts 602 are provided as an input to a mode selector 604. The mode selector 604 is configured to use the input noise amounts 602 to determine an operating mode that is to be used for speech enhancement processing.

For example, the mode selector 604 could use thresholds to differentiate between a set of speech enhancement processing modes. The values of the noise amounts 602 can be mapped to thresholds of the speech enhancement processing modes to enable a suitable speech enhancement processing mode to be selected. The different speech enhancement processing modes can be defined by the algorithmic delays of the respective speech enhancement processing modes. The algorithmic delays could have values of 2.5 ms, 5 ms, 10 ms and 20 ms or could take any other suitable values. In this example, for each of the input mono audio signals 202, the determined speech enhancement processing modes can be selected by

| | | |
|---|---|---|
| 2.5 | ms | if N(n) ≤ 0.08 |
| 5.0 | ms | if 0.08 ≤ N(n) < 0.2 |
| 10.0 | ms | if 0.2 ≤ N(n) < 0.4 |
| 20.0 | ms | if 0.4 < N(n) |

Other values for the delays and the associated noise amounts 602 could be used in other examples.

The mode selector 604 provides a set of mode selections 606 as an output. The mode selections 606 are a set of indicator values that define speech enhancement processing mode that has been selected. The respective mode selections 606 can indicate a speech enhancement processing mode for respective mono audio signals 200. The selected speech enhancement processing modes can be different for different input mono audio signals 200, therefore the different mode selections 606 can indicate the different speech enhancement processing modes.

The mode selections 606 are provided as an input to the speech enhancer 608. The speech enhancer 608 has multiple operating modes that can be used to perform speech enhancement processing. In other examples the speech enhancer 608 could comprise multiple different speech enhancement processing instances (for example different speech denoising machine learning models) where different instance provide different modes.

The speech enhancer 608 also receives the mono audio signals 200 as input. The speech enhancer 608 is configured to perform speech enhancement processing on the mono audio signals. The mode of operation that is used to perform the speech enhancement processing on the respective mono audio signals 200 is selected based on the input mode selections 606. Different speech enhancement processing can be used for different mono audio signals.

An example of a speech enhancer 608 is shown in more detail in FIG. 7 and described below.

The speech enhancer 608 provides the speech enhanced signals 610 as an output. The speech enhanced signals 610 are provided to a combiner 612. The combiner 612 can combine the speech enhanced signals 610 in any suitable manner. In the example of FIG. 6 the combiner 612 can create spatial audio signals 202 from the speech enhanced signals 610.

The spatial audio signals 202 can be individual to the respective client devices. For example, each client device 104 would receive a mix that does not comprise the audio originating from that client device 104.

The combiner 612 provides the spatial audio signals 202 as an output. The spatial audio signals 202 can be transmitted to the respective client devices 104. This can be as shown in FIGS. 2 and 5.

In the example of FIG. 6 the combiner 612 provides spatial audio signals 202 as an output. Other types of signals could be provided in other examples. For instance, if a client device 104 does not support spatial audio then the output signal for that client device 104 could be a sum of the speech enhanced signals 610 for that client device 104.

FIG. 7 shows an example speech enhancer 608 that could be used in examples of the disclosure. The speech enhancer 608 could be used in a processor 500 such as the processor 500 of FIG. 6. In a practical implementation, some of the blocks or operators can be merged or split into different subroutines, or can be performed in different order than described.

In the example of FIG. 7 the speech enhancer 608 is a speech enhancer 608 with multiple modes of operation. The speech enhancer 608 can receive multiple input signals and perform speech enhancement processing independently on the respective input signals. The speech enhancement processing modes that are used can be different for different input signals. The different modes of the speech enhancement processing can use similar processes but can use different configurations for the processes.

The speech enhancer 608 receives the mode selections 606 as an input. The mode selections 606 can be provided as an input to a window selector 700. The window selector 700 is configured to determine a window function that is to be used for performing transforms.

Any suitable process can be used to determine a window function. The window selector 700 provides a window parameter 702 as an output. The window parameter 702 can be provided to an STFT block 704 and an inverse STFT block 716.

In some examples a set of suitable window functions can be determined offline. The window selector 700 can be configured to select a window function for use. In such cases the window parameter 702 could be a window selection index.

The speech enhancer 608 also receives the mono audio signals 200 as an input. Other types of input audio signals could be used in other examples. The mono audio signals 200 are provided as an input to an STFT block 704. The STFT block 704 is configured to convert the mono audio signals 200 to a time frequency signal 706.

In some examples the STFT block 704 can take two frames of audio data (current frame and previous frame) and apply a window function the frames. The STFT block 704 can then apply a fast Fourier transform (FFT) on the result. This can achieve 961 unique frequency bins for a frame size of 960 samples. The window function that is applied can be determined by the window parameter 702 that is received by the STFT block 704.

The window parameter 702 can change over time and so the window function that is applied can also change over time.

The time-frequency signal 706 that is output from the STFT block 704 can be provided as an input to a speech enhancer model 708 and an apply mask gain block 712.

The speech enhancer model 708 can be a machine learning speech enhancer model or any other suitable type speech enhancer model. The speech enhancer model 708 can be configured to predict mask gains based on the time-frequency signal. The mask gains can be predicted using any suitable process.

The noisiness determiner 600 can also use an STFT and a speech enhancement model. In some examples data can be reused by the respective blocks.

The mask gains 710 that are predicted by the speech enhancer model 708 can be provided as an input to the apply mask gains block 712.

The apply mask gains block 712 applies the mask gains 710 to the time-frequency signal 706. The mask gains can be applied as described above as

$${S}_{speech} = g ( b , n ) S ( b , n ) ,$$

to obtain a speech enhanced time-frequency signal 714.

The speech enhanced time-frequency signal 714 is provided to an inverse STFT block 716. The inverse STFT block 716 also receives the window parameter 702 as an input. The inverse STFT block 716 is configured to convert the speech enhanced time-frequency signals 714 to speech enhanced signals 610. The speech enhanced signals 610 are the output of the speech enhancer 608.

In some examples the inverse STFT block 716 can be configured to apply an inverse fast Fourier transform (IFFT) to the received speech enhanced time-frequency signals 714 and then apply a window function to the result and the apply overlap-add processing. The overlap-add processing can be based on the window function indicated by the window parameter 702.

The window function that is selected by the window selector 700 can be selected based on the mode selections 606. The mode selections could be an indication of a delay such as 2.5 ms, 5 ms, 10 ms or 20 ms. If the system operates on a frame size of 960 samples and uses a 48000 Hz sample rate, then these delay values map to 120, 240, 480 and 960 samples. This sample delay value can be denoted as d(n) where the dependency of the temporal index n indicates that the parameter can change over time. Any changes in the parameter over time can happen sparsely, because of the significant temporal smoothing. In some examples there can be switching thresholds to avoid switching the delay value d(n) too often. The switching thresholds can be set so as to only allow a change of the delay value d(n) when the quality value (noise amount in this example) have indicated the need to change it over multiple consecutive frames, for example 100 frames.

In the present example, the window function can be denoted w(s) where 1≤s≤1920 is the sample index. 1920 is the length of two audio frames of length 960. First, the sample limit values can be denoted

$${s}_{1} ( n ) = ( 960 - d ( n ) )$$

$${s}_{2} ( n ) = 960$$

$${s}_{3} ( n ) = 1920 - d ( n )$$

Then the window function is

$$w ( s ) = \{ \begin{matrix}0 & if s \leq {s}_{1} ( n ) \\ sin ( 0.5 π \frac{s - {s}_{1} ( n )}{{s}_{2} ( n ) - {s}_{1} ( n )} ) & if {s}_{1} ( n ) < s \leq {s}_{2} ( n ) \\ 1 & if {s}_{2} ( n ) < s \leq {s}_{3} ( n ) \\ sin ( 0.5 π \frac{1920 - s}{1920 - {s}_{3} ( n )} ) & if {s}_{3} ( n ) < s\end{matrix}$$

FIG. 8 shows example window functions according to the above definition for different delay values d(n). The shaded areas indicate the portion of audio data that is the output at the inverse STFT operation. In other words, when one frame of frequency data having 961 unique frequency bins is converted to the time domain with IFFT, then after applying the window function as shown in the figure, the shaded area is the output PCM audio signal for that frame. The part that is after the shaded area is added to the early part of the next frame that is output, which is the overlap-add processing.

The window functions can be used in the STFT and the inverse STFT. The window functions can be used in any suitable way in the STFT and the inverse STFT. In some examples for the STFT the current frame and the previous frame are concatenated, forming the two frames (1920 samples) of data. The window function is then applied by sample-wise multiplication to that data. An FFT is then taken to obtain 961 unique frequency bins.

In some examples for the inverse STFT the frequency data is processed with the inverse FFT which results in two frames (1920 samples) of audio data. The window function is then applied to the signal and the overlap-add processing can be performed. The overlap-add processing can be performed as described below.

The overlap-add processing means that the frames provided by the consecutive inverse STFT overlap each other. The inverse FFT operation of the inverse STFT provides 1920 samples in this example but the inverse STFT outputs 960 samples. The output portion of the inverse STFT for the different window sizes is shown as the shaded area in FIG. 8.

The part that is after the shaded area is preserved and added to beginning of the next frame that is output. The preserved part of the previous frame fades out when the next frame fades in.

As shown in FIG. 8 the different window types that can enable the inverse STFT to provide different temporal parts of the data as an output. This causes the speech enhancement processing to operate with different amounts of latency. The latency caused by the combined operation of the STFT and the inverse STFT is d(n).

The inverse STFT will output newer audio data and thus smaller latency for smaller values of d(n). The inverse STFT will output older audio data and thus larger latency for larger values of d(n). This can enable the speech enhancement processing to operate with different amounts of latency.

When the inverse STFT is arranged to output newer audio data and operate with smaller latency this can have potential implications to the audio quality within the output audio signals, as described in the following.

An STFT can be considered to be an example of a generic complex-modulated filter bank. A complex-modulated filter bank can be one that has a low-pass prototype filter that is complex-modulated to different frequencies. These filters can be applied to the time-domain signal to obtain band-pass signals. Then, downsampling can be applied to the respective resulting filter outputs. This is a theoretical framework to consider filter banks, rather than an actual way of implementation. An STFT is an efficient example implementation of such a generic filter bank, where the downsampling factor is the hop size (which is the same as the frame size in our example), the prototype filter modulation takes place due to the appliance of the FFT operation, and, the low-pass prototype filter is the window function.

The features of the lowpass prototype filter (which is the window function) affects the performance of the filter bank so that when the window gets more rectangular (with smaller d(n)) then the prototype filter stop-band attenuation gets smaller. This means that at the processing of the audio in the STFT domain, more frequency aliasing will occur if the nearby frequency bands are processed differently. If this occurs then the aliasing does not cancel out. This can lead to roughness in the speech sounds when significant noise suppression takes place. The added amount of aliasing (and roughness) can be mitigated by smoothing (for example by using lowpass-filtering along the frequency axis) any processing gains applied to the nearby frequencies. However, this smoothing reduces the frequency selectivity of the processing to suppress noise components between speech harmonics.

FIG. 9 shows another example of operation of the processor 500 for some examples of the disclosure. In a practical implementation, some of the blocks or operators can be merged or split into different subroutines, or can be performed in different order than described.

This processor 500 is similar to the processor 500 shown in FIG. 6 and corresponding reference numerals are used for corresponding features. The processor 500 shown in FIG. 9 differs from the processor 500 shown in FIG. 6 in that in FIG. 9 the processor 500 comprises a latency determiner 900 instead of a noisiness determiner 600. This can enable latency to be used as a quality value. The latencies that could be determined could comprise the network latency. The network latency could comprise the delays in transmitting data from a sender to a receiver. If the network latency is determined to be high the speech enhancement processing could be adjusted so as have a lower algorithmic latency. Other quality related metrics could be used in other examples.

In the example of FIG. 9 the processor receives mono audio signals 200 as an input. Any number of mono audio signals 200 can be received. The mono audio signals 200 can be received from one or more client devices 104. In other examples other types of audio signals, such as spatial audio signals, can be received.

The processor 500 is configured to monitor the mono audio signals 200 with a latency determiner 900. The latency determiner 900 determines the amount of latency associated with the mono audio signals 200. The latency that is determined can be the network latency. The latency determiner 900 can determine latency values for the connections between the respective client devices and the server 102. Different connections can have different latency values.

Any suitable process can be used to determine the amount of latency associated with the mono audio signals 200. In some examples the latency can be estimated using quality of service information provided by Realtime Transport Control Protocol (RTCP). RTCP can provide sender and receiver reports that can be used to calculate round-trip-time (RTT) between the server 102 and a particular client device 104. Since RTT is a sum of latencies from a client device-to-server path and server-to-client device path, the client device-to-server latency can be approximated as RTT/2. This latency value can be determined for each of the client connections. RTCP sender and receiver reports can be received periodically. In some examples the RTCP sender and receiver reports can be received every 5 seconds or less frequently.

The latency determiner 900 provides latency amounts 902 as an output. The latency amounts 902 can be an example of a quality value and can be used to control an adjustment to speech enhancement processing. In some examples other parameters could be used as the quality value.

The latency amounts 902 are provided as an input to a mode selector 604. The mode selector 604 is configured to use the input latency amounts 902 to determine an operating mode that is to be used for speech enhancement processing.

The mode selector 604 can operate in a similar manner to the mode selector 604 shown in FIG. 6 except that the modes are selected based on the latency amounts 902 rather than a noise amount 602. The values of the latency amounts 902 can be mapped to thresholds of the speech enhancement processing modes to enable a suitable speech enhancement processing mode to be selected. In this example, for each of the input mono audio signals 200, the determined speech enhancement processing modes can be selected by

| | | |
|---|---|---|
| 2.5 | ms | if Latency > 40 ms |
| 5.0 | ms | else if Latency > 20 ms |
| 10.0 | ms | else if Latency > 10 ms |
| 20.0 | ms | else if Latency ≤ 10 ms |

Other values for the delays and the associated latency amounts 902 could be used in other examples.

The mode selector 604 provides a set of mode selections 606 as an output. The mode selections 606 are provided as an input to the speech enhancer 608. The speech enhancer 608 and the rest of the processor 500 shown in FIG. 9 can be as shown in FIG. 6.

The example processor shown in FIG. 9 enables a lower latency speech enhancement processing to be used for signals for which the latency was found to be high. This helps to limit the overall maximum latency and to reduce the probability of talker overtalk.

In some examples of the disclosure the systems 100 can be configured so that incoming sounds can be processed differently for different client devices 104. For example, if it is found that one client device 104 has a high latency connection to a server 102, then any sound provided to it from other client devices 104 can be processed with low-latency speech enhancement processing. This reduces the latency but also potentially reduces the quality of the speech enhancement. Then the same signals provided to another client device 104 for which a lower latency at the communication path is detected could be processed with higher latency speech enhancement processing which could provide improved speech enhancement.

FIG. 10 shows another example system 100 that can be used to implement examples of the disclosure. This system 100 comprises a server 102 connected to multiple client devices 104 so as to enable a communications session such as a teleconference between the respective client devices 104.

The example system 100 shown in FIG. 10 differs from the example system 100 shown in FIG. 2 in that, in FIG. 10 at least one of the client devices 1000 is configured to provide a spatial audio signal 202E to the server 102. The spatial audio signal 202E provided to the server 102 can be of a similar or a different kind to the spatial audio signal 202 provided from the server 102 to the client devices 104, 1000. The server 102 can be configured to merge the spatial audio signals and potential mono audio signals. Any suitable processes can be used to merge the signals.

In the example of FIG. 10 the client device 1000 generates a spatial audio signal 202E that is provided to the server 102. The client device 1000 can be any device that comprises two or more microphones. In this example the client device 1000 is a mobile phone, other types of client device 1000 could be used in other examples. The client device 1000 can be apply time-frequency processing to the microphone signals to create a spatial audio signal 202E. The time-frequency processing could comprise the use of STFT processing in analyzing the spatial metadata based on the microphone signals or could comprise any other suitable type of processing. The client device 1000 could also perform other types of processing such as beamforming. Beamforming can be performed best on raw signals rather than after encoding and decoding. This can mean that the client device 1000 can perform a forward time-frequency transform and a backward time-frequency transform. That is the client device 1000 can be performing both an STFT and an inverse STFT and causing the corresponding latency.

Therefore, in the example system 100 the client device 1000 already has significant algorithmic delays and so the server 102 can act so as to reduce any further latency. To do this the server 102 can send control data to the client device 1000 to enable the client device 1000 to speech enhancement processing or any other audio processing with different latencies. This can avoid the server 102 causing further latency by performing more forward and backward transforms.

The different latencies may be controlled as described previously, for example, by using different STFT windows at the client device 1000 or by using different amounts of look-ahead at a speech enhancer residing in the client device 1000. The speech enhancement processing that is used by the client device 1000 can be selected based on a quality value such as a noise amount 602 or a latency amount 902 or any other quality value.

In some examples of the disclosure a quality value and/or a mode selection can be locked to a specific value. In some examples the values can be locked after an initial convergence. In other examples the quality value and/or a mode selection can be dynamic and can change over time. The changes in the quality value and/or mode selection can change in response to changes in the system 100 such as a change in the noise or latencies. The changing of the quality value and/or mode selection over time can be implemented using the examples described herein. For example, the changes can be implemented by changing the window and the overlap-add processing. Even if the window changes, the overlap region of the previous frame is nevertheless added to the current frame as usual. Even if the overlap fade-in and fade-out are different in shape, they are still suitable for occasional mode switching. In some examples, the switching of the mode selection can be limited so that it does not happen too often, for example, not more often than once per second.

In examples where mode switching between higher latency mode and low latency mode occurs during runtime for audio signal, a stage of time-scale modification processing can be processed after or before the speech enhancement processing to gradually catch up the short latency mode of operation. This time-scale modification processing would be an analogous operation to the operations that take place in some adaptive jitter buffer implementations. However, in some examples, no time-scale modification is used and the mode switching relies on the windowing only.

In some examples of the disclosure, in a high-latency operating mode, a machine learning model used for the speech enhancement processing can be configured to have one or more frames of look-ahead to the future frames. This can enable the speech enhancer 608 to estimate the speech portion more robustly at the current frame. However, this would introduce an additional latency penalty by the amount of the look-ahead.

In the above described examples the quality values that were used to control the adjustment of the speech enhancement processing were based on latency associated with the obtained one or more audio signals or noise levels in the obtained one or more audio signals. In some examples the quality values could be based on a combination of the latency and noise levels. Other metrics, or combinations of metrics, could be used in other examples. Another example metric that could be used could be the coding/decoding bit rates associated with the obtained one or more audio signals. In such examples the speech enhancement processing can be adjusted so that for lower bit rates the latency of the speech enhancement processing is set to a lower value because the audio quality is already compromised due to the bit rate.

FIG. 11 shows example results that can be obtained using examples of the disclosure. These results were obtained using a prototype processing software to process audio at different noise levels to perform the processing according to the examples of the disclosure. The results shown in FIG. 11 were obtained using a processor 500 and speech enhancer 608 as shown in FIGS. 6 and 7 where the noise levels of the audio signals were estimated, and then based on the noise levels, the speech enhancement processing was adapted to use the appropriate STFT windows. This resulted in different latency and quality in the processing.

The prototype system was simulating the operation of the server 102 as described herein, however, the audio files were loaded from a disk instead of receiving them from remote client device 104. Pink noise was mixed to a speech signal with multiple levels. The noisiness measure N(n) was formulated otherwise the same as described in the foregoing, except that no temporal IIR averaging was performed. Instead the average noisiness measures were formulated for the entire file. The noisiness measures varied from input to input, due to the differing noise levels. The speech portion of the signal was the same in all items to enable visualizing the different delay occurring at different noise levels.

In the prototype implementation instead of using a machine learning model to determine the mask gains an idealized prototype model was used. The idealized prototype model was provided with the information of the energy levels of both the noisy speech and clean reference speech in logarithmic frequency resolution at each STFT frame, and the mask gains were formulated as the division of the clean speech energy by the noise energy, at each band and frame index. The mask gain values were limited between 0 and 1.

In the first row of the measured noisiness of the signal was 0.02, which is very low, and therefore the system 100 operates to allow use the of lowest 120 samples (2.5 milliseconds) latency mode. In the second row the measured noisiness was 0.28 which is fairly high, and therefore the system operates in the second-to-highest latency mode of 480 samples (10 milliseconds). In the third row the measured noisiness was 0.61 which is very high, and the system uses the highest latency processing of 960 samples (20 milliseconds).

The threshold values used to determine the latency mode based on the metric of measured noisiness N(n) were determined by listening to the processing result of the example system at different latency modes. The thresholds were then configured so that for any measured noisiness level, the lowest such latency mode is used that does not compromise the speech enhancement processing quality due to the shortened window. Therefore, the example according to FIG. 11 shows that the system adapts to switch to a lower-latency processing mode whenever allowable due to lower noise conditions.

FIG. 12 schematically illustrates an apparatus 1200 that can be used to implement examples of the disclosure. In this example the apparatus 1200 comprises a controller 1102. The controller 1102 can be a chip or a chip-set. The apparatus 1200 can be provided within a server 102 or a client device 104 or any other suitable type of device within a teleconferencing system 100.

In the example of FIG. 12 the implementation of the controller 1102 can be as controller circuitry. In some examples the controller 1102 can be implemented in hardware alone, have certain aspects in software including firmware alone or can be a combination of hardware and software (including firmware).

As illustrated in FIG. 12 the controller 1102 can be implemented using instructions that enable hardware functionality, for example, by using executable instructions of a computer program 1204 in a general-purpose or special-purpose processor 500 that may be stored on a computer readable storage medium (disk, memory etc.) to be executed by such a processor 500.

The processor 500 is configured to read from and write to the memory 502. The processor 500 can also comprise an output interface via which data and/or commands are output by the processor 500 and an input interface via which data and/or commands are input to the processor 500.

The processor 500 can be as shown in FIG. 5.

The memory 502 stores a computer program 1204 comprising computer program instructions (computer program code 504) that controls the operation of the controller 1200 when loaded into the processor 500. The computer program instructions, of the computer program 1204, provide the logic and routines that enables the controller 1102. to perform the methods illustrated in the accompanying Figs and described herein. The processor 500 by reading the memory 502 is able to load and execute the computer program 1204.

The memory 502 can be as shown in FIG. 5.

The apparatus 1200 comprises:
at least one processor 500; and
at least one memory 502 storing instructions that, when executed by the at least one processor 500, cause the apparatus 1200 at least to perform:
   obtaining 300 one or more audio signals during audio communication;
   determining 302 at least one quality value for at least one of the obtained one or more audio signals; and
   enabling adjustment 304 of speech enhancement processing used for at least one of the one or more obtained audio signals wherein the adjustment is based, at least in part, on the quality value.

As illustrated in FIG. 12, the computer program 1204 can arrive at the controller 1202 via any suitable delivery mechanism 1206. The delivery mechanism 1206 can be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 1204. The delivery mechanism can be a signal configured to reliably transfer the computer program 1204. The controller 1202 can propagate or transmit the computer program 1204 as a computer data signal. In some examples the computer program 1204 can be transmitted to the controller 1202 using a wireless protocol such as Bluetooth, Bluetooth Low Energy, Bluetooth Smart, 6LoWPan (IPᵥ6 over low power personal area networks) ZigBee, ANT+, near field communication (NFC), Radio frequency identification, wireless local area network (wireless LAN) or any other suitable protocol.

The computer program 1204 comprises computer program instructions for causing an apparatus 1200 to perform at least the following or for performing at least the following:
obtaining 300 one or more audio signals during audio communication;
determining 302 at least one quality value for at least one of the obtained one or more audio signals; and
enabling adjustment 304 of speech enhancement processing used for at least one of the one or more obtained audio signals wherein the adjustment is based, at least in part, on the quality value.

The computer program instructions can be comprised in a computer program 1204, a non-transitory computer readable medium, a computer program product, a machine readable medium. In some but not necessarily all examples, the computer program instructions can be distributed over more than one computer program 1204.

Although the memory 502 is illustrated as a single component/circuitry it can be implemented as one or more separate components/circuitry some or all of which can be integrated/removable and/or can provide permanent/semi-permanent/dynamic/cached storage.

Although the processor 500 is illustrated as a single component/circuitry it can be implemented as one or more separate components/circuitry some or all of which can be integrated/removable. The processor 500 can be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the Figs. And described herein can represent steps in a method and/or sections of code in the computer program 1204. The illustration of a particular order to the blocks does not necessarily imply that there is a required or preferred order for the blocks and the order and arrangement of the blocks can be varied. Furthermore, it can be possible for some blocks to be omitted.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1. An apparatus for speech enhancement processing, the apparatus comprising:
at least one processor; and
at least one memory storing instructions that, when executed with the at least one processor, cause the apparatus at least to:
obtain one or more audio signals during audio communication;
determine at least one quality value for at least one of the obtained one or more audio signal; and
enable adjustment of speech enhancement processing used for at least one of the one or more obtained audio signals wherein the adjustment is based, at least in part, on the at least one quality value.

2. The apparatus as claimed in claim 1, wherein the determined at least one quality value is based on at least one of:
latency associated with the obtained one or more audio signals;
noise levels in the obtained one or more audio signals; or
coding/decoding bit rates associated with the obtained one or more audio signals.

3. The apparatus as claimed in claim 1, wherein the instructions, when executed with the at least one processor, cause the apparatus to determine the at least one quality value using a machine learning model.

4. The apparatus as claimed in claim 1, wherein the instructions, when executed with the at least one processor, cause the apparatus to adjust the speech enhancement processing to operate with smaller latency if the determined at least one quality value indicates at least one of:
that the latency associated with the obtained one or more audio signals is higher; or
that the noise levels in the obtained one or more audio signals is lower.

5. The apparatus as claimed in claim 1, wherein the instructions, when executed with the at least one processor, cause the apparatus to adjust the speech enhancement processing to operate with larger latency if the determined at least one quality value indicates at least one of:
that the latency associated with the obtained one or more audio signals is lower; or
that the noise levels associated with the obtained one or more audio signals is higher.

6. The apparatus as claimed in claim 1, wherein the instructions, when executed with the at least one processor, cause the apparatus to adjust speech enhancement processing based on selecting at least one of a plurality of available modes for use in speech enhancement processing.

7. The apparatus as claimed in claim 6, wherein the instructions, when executed with the at least one processor, further cause the apparatus to select a window function for performing one or more transforms of the one or more audio signals, wherein the window function is selected based, at least in part, on the selected mode.

8. (canceled)

9. The apparatus as claimed in claim 1, wherein the instructions, when executed with the at least one processor, cause the apparatus to determine a first quality value for a first obtained audio signal and a second, different quality value for a second obtained audio signal; and
wherein the instructions, when executed with the at least one processor, cause the apparatus to apply a first speech enhancement processing to the first obtained audio signal based, at least in part, on the first quality value and to apply a second speech enhancement processing to the second obtained audio signal based, at least in part, on the second quality value, wherein the first speech enhancement processing and the second speech enhancement processing have different latencies.

10. The apparatus as claimed in claim 1, wherein the obtained one or more audio signals comprise at least one of:
one or more mono audio signals,
one or more stereo audio signals;
one or more multichannel audio signals; or
one or more spatial audio signals.

11. The apparatus as claimed in claim 1, wherein the speech enhancement processing comprises at least one of:
speech denoising;
automatic gain control; or
bandwidth extension.

12. (canceled)

13. A method, comprising:
obtaining one or more audio signals during audio communication;
determining at least one quality value for at least one of the obtained one or more audio signals; and
enabling adjustment of speech enhancement processing used for at least one of the one or more obtained audio signals wherein the adjustment is based, at least in part, on the at least one quality value.

14. (canceled)

15. The method as claimed in claim 13, wherein the speech enhancement processing is adjusted to operate with larger latency if the determined at least one quality value indicates at least one of:
that the latency associated with the obtained one or more audio signals is lower; or
that the noise levels associated with the obtained one or more audio signals is higher.

16. The method as claimed in claim 13, wherein adjusting speech enhancement processing comprises selecting at least one of a plurality of available modes for use in speech enhancement processing.

17. The method as claimed in claim 16, further comprising selecting a window function for performing one or more transforms of the one or more audio signals, wherein the window function is selected based, at least in part, on the selected mode.

18. The method as claimed in claim 13, wherein a first quality value is determined for a first obtained audio signal and a second, different quality value is determined for a second obtained audio signal; and
a first speech enhancement processing is applied to the first obtained audio signal based, at least in part, on the first quality value and a second speech enhancement processing is applied to the second obtained audio signal based, at least in part, on the second quality value, wherein the first speech enhancement processing and the second speech enhancement processing have different latencies.

19. The method as claimed in claim 13, wherein the obtained one or more audio signals comprise at least one of:
one or more mono audio signals,
one or more stereo audio signals;
one or more multichannel audio signals; or
one or more spatial audio signals.

20. The method as claimed in claim 13, wherein the speech enhancement processing comprises at least one of:
speech denoising;
automatic gain control; or
bandwidth extension.
